(19) United States
(12) Patent Application Publication
(10) Pub. No.: US 2004/0100921 A1
(43) Pub. Date: May 27, 2004

(54) Time-orthogonal CDMA wireless communication system

(76) Inventor: Farooq Ullah Khan, Manalapan, NJ (US)

Correspondence Address: HARNESS, DICKEY & PIERCE, P.L.C., P.O. Box 8910, Reston, VA, 20195, US

(21) Appl. No.: 10/305,172

(22) Filed: Nov. 27, 2002

(51) Int. Cl. H04B 7/212

(52) U.S. Cl. 370/321; 455/522

(57) ABSTRACT

The system provides a slot-synchronized reverse link and transmission scheme where high-speed data transmissions are made possible by carrying the high-speed data transmission in slots orthogonal to the slots carrying control, voice and other low rate data transmission.

### BACKGROUND OF THE INVENTION

In the evolving wireless data systems, such as the well-known 1x-EV-DO and 1xEV-DV standards as well as the High Speed Downlink Packet Access (HSDPA) specification in the Universal Mobile Telecommunication System (UMTS) standard, the forward link (base station to mobile station(s)) capacity has been increased by using techniques such as fast scheduling, adaptive modulation and coding (AMC) and hybrid ARQ (HARQ). In general, a scheduler, for example in the base station, selects a user for transmission at a given time and adaptive modulation and coding allows selection of the appropriate transport format (modulation and coding) for the current channel conditions seen by the user. Due to errors in channel quality estimates, high error rates result in the transmissions performed at a given rate (transport format). Hybrid ARQ, which makes use of fast retransmissions and combining a newly received copy of the transmission with the previously received copies, allows for recovery from transmission errors.

Further evolution of 3G standards includes high-speed reverse link packet access (mobile station to base station). The reverse link is different from the forward link in the sense that the transmissions from different users are not orthogonal. In a CDMA system, both the forward link and the reverse link use orthogonal Walsh codes for spreading. Since the signal is transmitted from a fixed location (base station) on the forward link, the different Walsh codes are still orthogonal when they arrive at the receiver. This is not the case on the reverse link due to the fact that the propagation times from mobiles at different locations to the base station are different. Therefore, orthogonality cannot be guaranteed for signals coming from different mobiles. However, transmissions from the same mobile on different channels can still be orthogonal. The transmissions from multiple users interfere with each other contributing to the noise rise seen by each of the users. In general, the noise rise at the base station is kept below a certain threshold called the rise-over-thermal (RoT) threshold in order to guarantee desirable capacity and coverage. The circuitry of the base station generates a certain amount of temperature dependent noise called thermal noise. The RoT threshold limits the amount of power above the thermal noise at which mobiles can transmit. This limits the achievable data rates and capacity for high-speed packet transmissions on the reverse link.

### SUMMARY OF THE INVENTION

The present invention provides a time-orthogonal reverse link channel (mobile station to base station) whereby some of the slots within a frame, referred as burst (B) slots herein, are used for high speed data transmissions while the remaining slots, referred to as power control (PC) slots herein, are used to carry low data rate transmissions and physical layer control signaling according to any well-known standard.

The transmissions in power control slots carry low rate data transmission and physical layer control signaling and are power controlled as in a conventional CDMA system. The Rise-over-Thermal (RoT) is kept below a RoT threshold in these power control slots in order to guarantee an acceptable capacity/coverage to the critical real-time traffic such as voice and physical layer control signaling. The burst slots are used for high-speed data transmissions in a time-multiplexed fashion, i.e. only one user transmits within a burst slot. The transmission within a burst slot is in one exemplary embodiment performed at a mobile's peak power, but as described in detail below, the transmission within a burst slot is controllable and can be at some fraction of the mobile's peak power. Furthermore, the arrangement of burst slots and power control slots in the reverse link channel is controllable, as is the data rate of transmission during a burst slot.

Since only a single user transmits during a burst slot, there is no interference from the users in the same cell. Therefore, no RoT constraint needs to be respected i.e. the RoT during burst slots can be very high with a large power from the user scheduled in the burst slot. Namely, a mobile transmitting during a burst slot will transmit at a higher power than during a power control slot and will transmit at a power level regardless of the RoT threshold. This allows maximizing the received signal quality at the base station and therefore achieving very high data rates.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 shows a reverse link channel having alternating power control and burst slots according to an embodiment of the present invention;

FIG. 2 illustrates an example of low rate data transmission (e.g., voice frames) in the power control slots of the reverse link channel shown in FIG. 1;

FIG. 3 illustrates an example of scheduling and encoder packet transmission according to an embodiment of the present invention;

FIGS. 4-6 illustrates additional exemplary embodiments of scheduling and encoder packet transmission according to the present invention;

FIGS. 7 and 8 illustrate additional exemplary arrangements of power control and burst slots in frame; and

FIGS. 9-11 illustrate additional exemplary embodiments of encoder packet transmission over one or more burst slots.

### DETAILED DESCRIPTION

The present invention provides a time-orthogonal reverse link channel (mobile station to base station) whereby some of the slots within a frame, referred as burst (B) slots herein, are used for high speed data transmissions while the remaining slots, referred to as power control (PC) slots herein, are used to carry low data rate transmissions and physical layer control signaling according to any well-known standard. The reverse link (RL) transmissions from different users are slot-synchronized. The slot synchronization is achieved by adjusting the mobile transmit timing in such a way that the signals from multiple mobile stations arrive at the base station within some pre-specified delay threshold. For users in soft-handoff (SHO), the timing advance can be adjusted to minimize the transmission overlap across the cells in SHO. The reception at different cells may also be synchronized (to control inter-cell interference). In another embodiment of the invention, the mobiles transmit timing are not adjusted. Therefore, some degree of overlap depending upon the mobiles distance from the base station may happen.

The invention will be described in the context of the 1xEV-DO (aka HRPD) system. However, the principles of the present invention can also be applied to other CDMA systems such as cdma2000 (1xEV-DV), UMTS systems, etc.

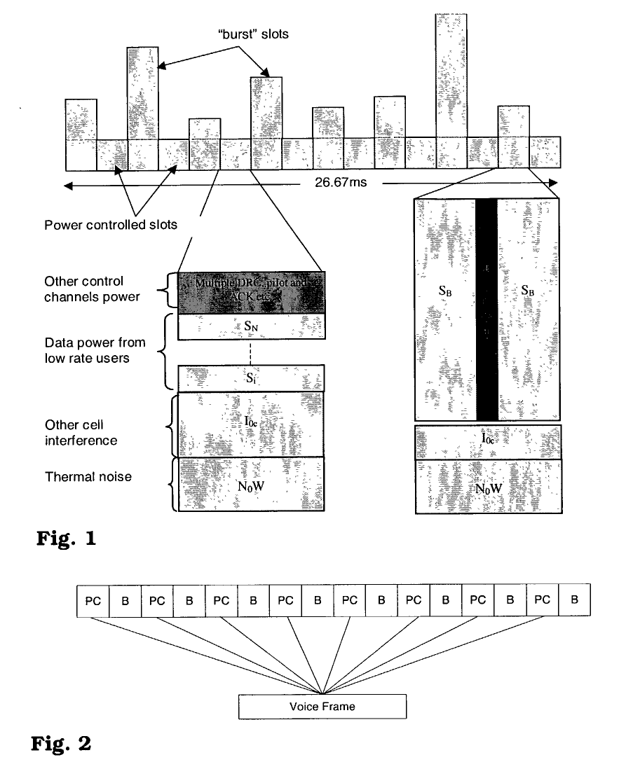

The physical layer signaling in 1xEV-DO, among others, consists of pilot, channel quality feedback and ACK/NACK feedback for the HARQ operation as shown for one of the power control slots in FIG. 1. FIG. 1 shows a reverse link channel having alternating power control and burst slots. The transmissions in power control slots carry low rate data transmission and physical layer control signaling and are power controlled as in a conventional CDMA system. The Rise-over-Thermal (RoT) is kept below a RoT threshold in these PC slots in order to guarantee an acceptable capacity/coverage to the critical real-time traffic such as voice and physical layer control signaling. The burst slots are used for high-speed data transmissions in a time-multiplexed fashion i.e. only one user transmits within a slot. The transmissions within a burst slot are in one exemplary embodiment performed at a mobile's peak power, but as described in detail below, the transmissions within a burst slot are controllable and can be at some fraction of the mobile's peak power. Since only a single user transmits during a burst slot, there is no interference from the users in the same cell. Therefore, no RoT constraint needs to be respected i.e. the RoT during burst slots can be very high with a large power from the user scheduled in the burst slot. Namely, a mobile transmitting during a burst slot will transmit at a higher power than during a power control slot and will transmit at a power level regardless of the RoT threshold. This allows maximizing the received signal quality at the base station and therefore achieving very high data rates.

An example of data rates in burst slots is given in Table 1 below. The encoder packet transmission duration is assumed to be 1 slot (1.67 ms). However, transmission duration of other than 1 slot can also be used to support high data rate transmissions in the burst slot. For example, the transmission duration can be fraction of a slot (e.g., ½ or ¼ of a slot) or consist of several slots.

A time-multiplexed pilot is assumed in each burst slot. Note that, as shown in FIG. 1, the pilot can also be code-multiplexed within the burst slot, where SB represents the burst signal power. The pilot in the burst slot serves at least two purposes: (1) channel estimation for demodulation and decoding of the traffic information, and (2) channel quality estimation of the current transmission. The channel quality estimate can be used to select an appropriate modulation and coding scheme for any other new transmissions or retransmissions to the same user. The spreading is done by a single Walsh code in order to minimize the impact on peak-to-average (PAR) requirements of the mobile station power amplifier. Note that at very high data rates, the spreading is zero. Multicode transmissions can also be considered if PAR requirements can be met.

TABLE 1
Data rates

| | Encoder | | | | Num- | Num- | |
|---|---|---|---|---|---|---|---|
| Debt | packet | | | SF | ber of | ber of | T/P |
| rate | size | Modu- | Coding | (Single | data | pilot | ratio |
| [Kb/s] | [bits] | lation | rate | code) | chips | chips | [dB] |
| 4003.2 | 6672 | 16-QAM | 0.834 | 1 | 2000 | 48 | 16.20 |
| 3686.4 | 6144 | 16-QAM | 0.768 | 1 | 2000 | 48 | 16.20 |
| 3072.0 | 5120 | 16-QAM | 0.640 | 1 | 2000 | 48 | 16.20 |
| 2457.6 | 4096 | 8-PSK | 0.688 | 1 | 1984 | 64 | 14.91 |
| 1843.2 | 3072 | 8-PSK | 0.525 | 1 | 1952 | 96 | 13.08 |
| 1228.8 | 2048 | QPSK | 0.533 | 1 | 1920 | 128 | 11.76 |
| 614.4 | 1024 | QPSK | 0.276 | 2 | 1856 | 192 | 9.85 |
| 307.2 | 512 | QPSK | 0.276 | 2 | 1856 | 192 | 9.85 |
| 153.6 | 256 | QPSK | 0.276 | 4 | 1856 | 192 | 9.85 |
| 76.8 | 128 | BPSK | 0.276 | 4 | 1856 | 192 | 9.85 |

An example, of low rate data transmission (e.g., voice frames) in the PC slots is shown in FIG. 2. Note that multiple simultaneous code-multiplexed transmissions can be performed in the PC slots. However, a single user transmits during a burst slot.

In operation, the base station generates and sends a scheduling or schedule grant message on the forward link. In one exemplary embodiment, the scheduling grant message includes a scheduling grant message indicator to indicate that the message is a schedule grant message. In another embodiment, a forward link channel (e.g., an entire physical channel or slots of a physical channel) is dedicated to transmission of schedule grant messages.

In one exemplary embodiment, the scheduling grant message includes one or more mobile identifiers. Associated with each mobile identifier in the schedule grant message are a slot indicator, a data rate indicator and a power level indicator. The mobile identifier is any well-known identifier for a base station to identify a mobile station. The slot indicator indicates the one or more slots in the reverse link channel over which the mobile station identified by the associated mobile identifier should perform a burst slot transmission. The data rate indicator indicates the data rate of the burst slot transmission. The power level indicator indicates the power level that the mobile station should transmit at during the burst slot transmission.

It will be understood that one or more of the schedule grant message parameters associated with a mobile identifier can be fixed for a given wireless communication system. This would then eliminate the need for having this parameter in the schedule grant message. For example, if the power level for a given wireless communication system were fixed at peak power or some fraction thereof, then this would eliminate the need for the power level indicator in the schedule grant message. As another example, because of the known timing relationship between the forward link and reverse link as well as the time needed for the mobile station to generate an encoder packet, a standard can fix burst slot transmission by a mobile station identified by the mobile station identifier in the reverse link channel slot following generation of the encoder slot in response to the schedule grant message. This would eliminate the need to provide the slot indicator in the schedule grant message. As a further example, the data rate can be fixed, or made dependent on the power level at which the mobile is able to transmit during the burst slot. This would eliminate the need for the data rate indicator.

Mobile stations monitor the forward link and identify the schedule grant messages based on the message indicator or based on the forward link channel being monitored. For identified schedule grant messages, mobile stations determine whether their mobile identifier is contained in the schedule grant message. Further processing of the schedule grant message depends on the standardization of the schedule grant message.

If the standard has not fixed the format of the reverse link channel including burst slots, then the schedule grant message will include one or more slot indicators in association with each mobile identifier. In this embodiment, each mobile determines the burst slots from the slot indicators regardless of whether their mobile identifier is included in the schedule grant message. In this manner, each mobile identifies the burst slots, and for those burst slots in which the mobile has not been scheduled to transmit, the mobile does not transmit. If the standard has fixed the format of the reverse link channel including burst slots, then mobile stations only need to initially examine the schedule grant message for their identifiers. If a mobile station does not find its identifier in the schedule grant message, no further processing of the schedule grant message is required. By not finding its mobile identifier, a mobile station will remain silent during the burst slots of the reverse link channel.

However, when a mobile station in either the fixed or flexible burst slot embodiments identifies its mobile identifier in the schedule grant message, the mobile station accesses the data rate indicator (if present) and the power level indicator (if present) associated with its mobile identifier in the schedule grant message. The mobile then generates an encoder packet in the well-known manner and transmits the encoder packet during the burst slot fixed by the standard or identified by the slot indicator. The mobile transmits the encoder packet at a data rate identified by the data rate indicator and at a power level identified by the power level indicator.

As will be appreciated, if a standard fixes the data rate, power level and format of the reverse link channel, then mobiles will only examine the schedule grant message for their mobile identifiers.

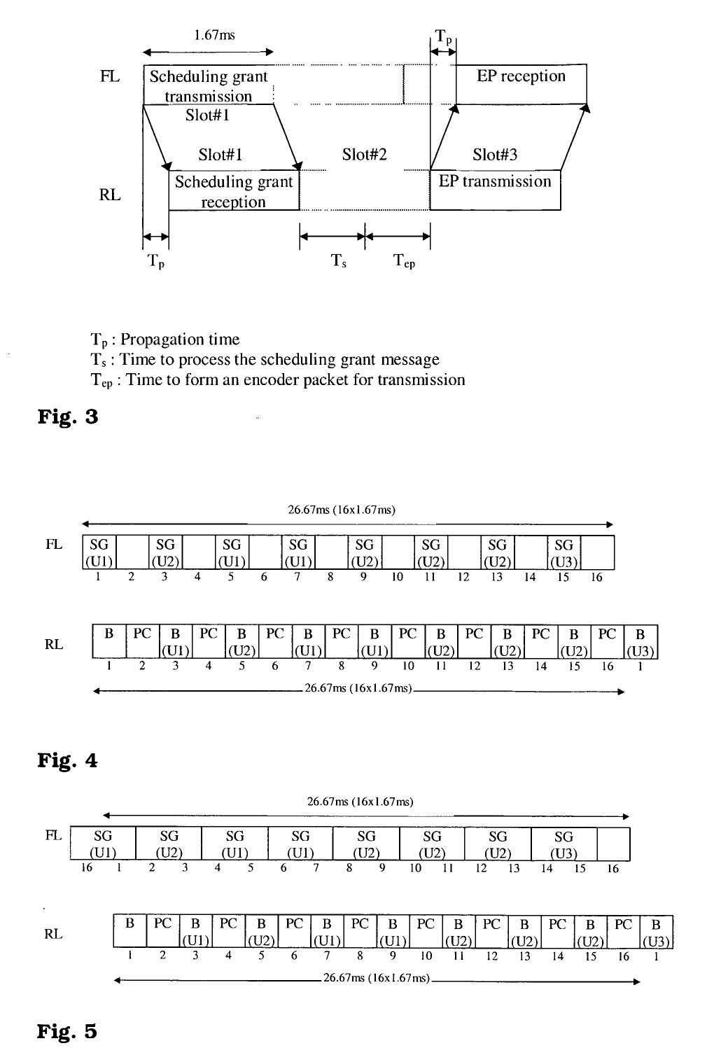

An example of scheduling and encoder packet transmission is shown in FIG. 3. In this example, the format, data rate and power level are fixed by the standard. The format is fixed to alternate power control and burst slots as shown in FIG. 1. As shown in FIG. 3, the base station sends the schedule grant message over one slot (1.67 ms) that includes a mobile station identifier. After some propagation delay (Tₚ), the identified mobile station receives the grant message in slot#1. In slot#2, after time Tₛ to process the scheduling grant message, the mobile station identifies its identifier in the schedule grant message. In response to this identification, the mobile station during time Tₑₚ forms an encoder packet and transmits the encoder packet in slot#3. The base station always knows the identity of the mobile station transmitted during a particular slot due to the fixed timing relationship between schedule grant message transmission by the base station and encoder packet transmission by the mobile station (i.e. for every scheduling grant message sent on the forward link in slot#i, the encoder packet is transmitted in slot#(i+2) on the reverse link). Therefore, the mobile station does not need to include its identifier with encoder packet transmission.

Another example of encoder packet scheduling is given in FIG. 4. In this example, both the scheduling grant transmission duration and encoder packet transmission duration is one slot (1.67 ms). In this example, mobile station U1 transmits in slots 3, 7 and 9 on the reverse link (RL), mobile station U2 transmits in slots 5, 11, 13 and 15 and mobile station U3 transmits in slot 1.

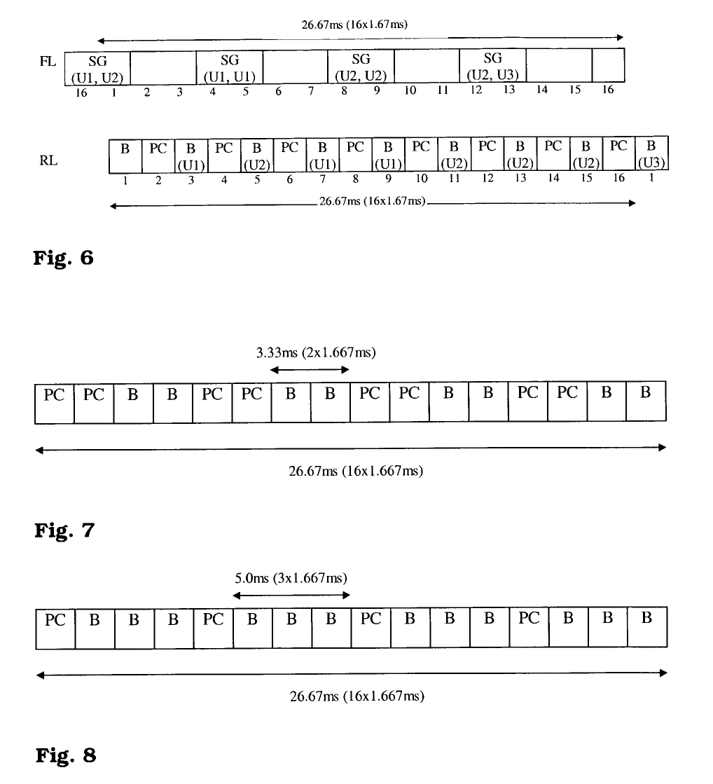

FIG. 5 shows an example where the scheduling grant transmission duration is 2 slots (3.33 ms) while the encoder packet duration is one slot (1.67 ms). FIG. 6 shows an example where a single schedule grant message carries information for more than one encoder packet transmissions—the two encoder packet transmission being for different mobiles.

FIGS. 7 through 8 illustrate some exemplary arrangements of the power control and burst slots within a 26.67 ms frame. In FIG. 7 two consecutive burst slots are scheduled for each two consecutive power control slots (a 2-2 configuration). In FIG. 8 three consecutive burst slots are scheduled for each power control slot (a 1-3 configuration).

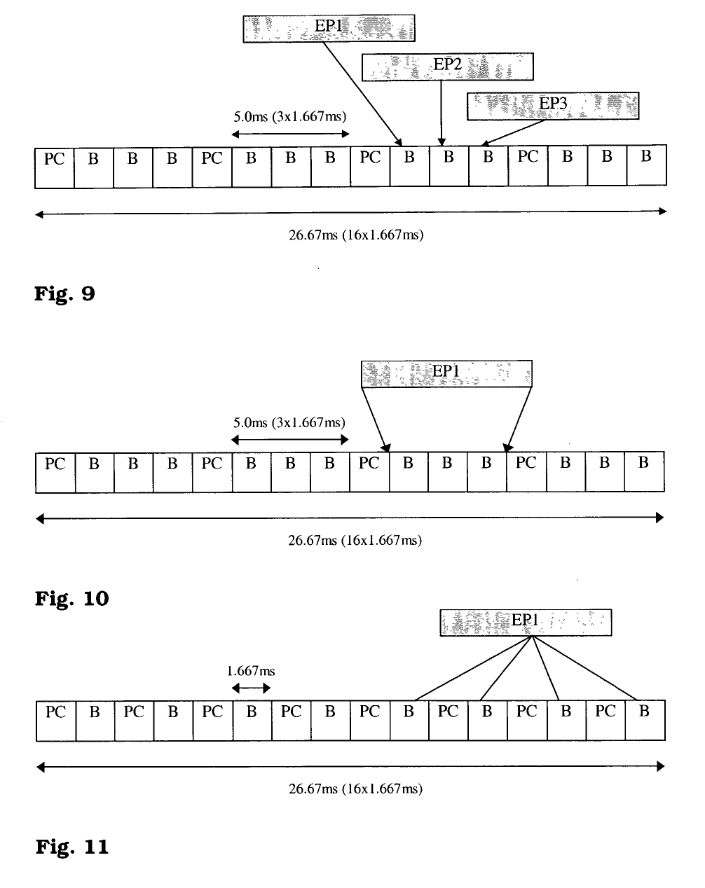

It will be further appreciated that depending on the data rate and standard, one or more encoder packets or only a portion of an encoder packet can be transmitted during a burst slot. FIG. 9 shows that each encoder packet (EP) is transmitted over a single burst slot of the 1-3 configuration. FIG. 10 shows each encoder packet (EP) is transmitted over three consecutive burst slots of the 1-3 configuration, and FIG. 11 shows an encoder packet (EP) is transmitted over four non-consecutive burst slots in the 1-1 configuration of FIG. 1.

In cases where the burst mode of transmission according to the present invention has to coexist with simultaneous power control slot transmission, e.g., from legacy mobiles, a high-speed data user can still be allowed to transmit at, for example, peak power during the burst slot. The increased interference in the power control slots of the legacy mobiles can be compensated for to some extent by increasing the outer loop power control set point for those mobiles. Another possibility is to employ interference cancellation in order to subtract the burst user signal from the overall received signal. This way the stronger signal from the burst user can first be detected and subtracted form the overall signal reducing the impact of burst user on power controlled legacy transmissions.

The cancellation technique, in another exemplary embodiment of the present invention, can also be applied to allow a limited number of non-legacy mobiles to transmit during a burst slot.

The present invention provides a transmission scheme on a slot-synchronized reverse link of a CDMA wireless system where the high-speed data transmissions are carried in slots that are orthogonal to the slots carrying control, voice and other low rate data transmission.

The invention being thus described, it will be obvious that the same may be varied in many ways. Such variations arc not to be regarded as a departure from the spirit and scope of the invention, and all such modifications are intended to be included within the scope of the following claims.

We claim:

1. A method of transmitting information over a reverse link by a mobile, comprising:
transmitting at a higher power than that established by a power control algorithm during a burst slot of a reverse link channel.

2. The method of claim 1, wherein the transmitting step transmits at the higher power level in response to a schedule grant message.

3. The method of claim 2, further comprising:
receiving the schedule grant message, the schedule grant message including at least one mobile identifier; and wherein
the transmitting step transmits at the higher power when the mobile identifier in the schedule grant message matches a mobile identifier of the mobile.

4. The method of claim 3, further comprising:
performing no transmission when the schedule grant message does not include a mobile identifier of the mobile.

5. The method of claim 3, further comprising:
generating an encoder packet in response to the received schedule grant message when the mobile identifier in the schedule grant message matches a mobile identifier of the mobile; and wherein
the transmitting step transmits the encoder packet.

6. The method of claim 3, wherein
the schedule grant message includes a data rate; and
the transmitting step transmits at the data rate.

7. The method of claim 3, wherein
the schedule grant message includes a power level; and
the transmitting step transmits at the power level.

8. The method of claim 3, wherein
the schedule grant message includes a slot indicator associated with the mobile identifier identifying a burst slot on the reverse link channel; and
the transmitting step transmits at the higher power level during the identified burst slot when the mobile identifier in the schedule grant message matches a mobile identifier of the mobile.

9. The method of claim 2, wherein the schedule grant message includes a power level; and
the transmitting step transmits at the power level.

10. The method of claim 2, wherein
the schedule grant message includes a slot indicator identifying a burst slot on the reverse link channel; and
the transmitting step transmits at the higher power level during the identified burst slot.

11. The method of claim 1, wherein the higher power is a peak power of the mobile scheduled to transmit during the burst slot.

12. The method of claim 1, wherein the higher power is a fraction of the peak power of the mobile scheduled to transmit during the burst slot.

13. The method of claim 1, further comprising:
generating at least one encoder packet in response to a received schedule grant message; and wherein
the transmitting step transmits at least a portion of the encoder packet.

14. The method of claim 13, wherein the transmitting step transmits one encoder packet over a single burst slot.

15. The method of claim 13, wherein the transmitting step transmits one encoder packet over more than one burst slot.

16. The method of claim 1, further comprising:
transmitting at a power established according to a power control algorithm during power control slots of the reverse link channel.

17. The method of claim 16, wherein the power control slots are time orthogonal to the burst slots.

18. A method of transmitting information over a reverse link by a mobile, comprising:
transmitting at a power level during a burst slot of a reverse link channel regardless of a RoT threshold.

19. A method of controlling transmission over reverse links by mobiles, comprising:
transmitting a schedule grant message on a forward link channel, the schedule grant message identifying at least one mobile to transmit at a higher power level than that established by a power control algorithm during a burst slot of a reverse link channel.

20. The method of claim 19, wherein the schedule grant message includes at least one mobile identifier identifying the mobile.

21. The method of claim 19, wherein the schedule grant message includes a data rate indicator indicating a data rate at which the mobile is to transmit during the burst slot.

22. The method of claim 19, wherein the schedule grant message includes a power level indicator indicating a power level at which the mobile is to transmit during the burst slot.

23. The method of claim 19, wherein the schedule grant message includes a slot identifier identifig the burst slot in the reverse link channel over which the mobile is to transmit.

24. The method of claim 19, wherein the schedule grant message identifies more than one mobile to transmit at a high power level, and identifies different burst slots of the reverse link channel over which each mobile is to transmit.

25. The method of claim 19, further comprising:
scheduling which slots of the reverse link channel will be burst slots; and wherein
the transmitting step transmits one or more schedule grant messages based on the scheduling.

26. The method of claim 25, wherein the scheduling step schedules every other slot of the reverse link channel as a burst slot.

27. The method of claim 25, wherein the scheduling step schedules two consecutive burst slots for each two consecutive non-burst slots.

28. The method of claim 25, wherein the scheduling step schedule three consecutive burst slots for each non-burst slot.

29. The method of claim 25, wherein the scheduling step schedules which mobile will transmit during which burst slot.

30. The method of claim 25, further comprising:
adjusting a threshold of the power control algorithm such that at least one mobile unable to operate according to the schedule grant message increases transmission power during non-burst slots of the reverse link channel.

31. The method of claim 19, further comprising:
receiving an overall signal;
detecting a burst transmission signal in the overall signal; and
performing interference cancellation on the overall signal using the detected burst transmission signal.

32. A method of controlling transmission over reverse links by mobiles, comprising:
transmitting a schedule grant message on a forward link channel, the schedule grant message identifying at least one mobile to transmit during a burst slot of a reverse link channel regardless of a RoT threshold.
